(19) United States
(12) Patent Application Publication
(10) Pub. No.: US 2019/0087352 A1
(43) Pub. Date: Mar. 21, 2019

(54) METHOD AND SYSTEM TRANSMITTING DATA BETWEEN STORAGE DEVICES OVER PEER-TO-PEER (P2P) CONNECTIONS OF PCI-EXPRESS

(71) Applicant: SAMSUNG ELECTRONICS CO., LTD, SUWON-SI (KR)

(72) Inventors: JU-PYUNG LEE, YEONSU-GU, INCHEON (KR); JOO-YOUNG HWANG, SEOUL (KR)

(21) Appl. No.: 15/959,320

(22) Filed: Apr. 23, 2018

(30) Foreign Application Priority Data
Sep. 21, 2017 (KR) 10-2017-0121874

(51) Int. Cl. G06F 12/127; G06F 12/1018; G06F 12/122; G06F 12/123; G06F 12/02; G06F 13/42; H04L 29/08

(52) U.S. Cl. CPC G06F 12/127; G06F 12/1018; G06F 12/122; G06F 12/123; G06F 2212/7201; G06F 13/4221; H04L 67/2842; H04L 67/104; G06F 2213/0026; G06F 12/0246

(57) ABSTRACT

Provided are a method and a system for transmitting data between storage devices over peer-to-peer (P2P) connections of peripheral component interconnect-express (PCIe). The method, performed when a first storage device receives a data request from a host, includes caching data of another storage device via PCIe connection in response to the data request, and transmitting the cached data to the host. The first storage device is configured to convert a logical address received with the data request to a physical address of a memory region of a second storage device, to store data transmitted from the second storage device via the PCIe connection in a second data cache according to the converted physical address, and to perform a cache replacement scheme for the data stored in the second data cache.

### CROSS-REFERENCE TO RELATED APPLICATION

This application claims the benefit of Korean Patent Application No. 10-2017-0121874, filed on Sep. 21, 2017, in the Korean Intellectual Property Office, the subject matter of which is incorporated herein in its entirety by reference.

### BACKGROUND

The inventive concept relates to storage systems and methods of transmitting data between peers devices in the storage system. More particularly, the inventive concept relates to methods and systems capable of transmitting data between storage devices over peer-to-peer (P2P) connections of a peripheral component interconnect-express (PCIe).

Solid state drives (SSDs) are high-performance, high-speed storage devices that store data in non-volatile memories. The operating speeds of computers communicating with storage devices, as well as various host devices (hereafter, “hosts”) such as smart phones and smart pads, have generally increased. Further, the content capacity of storage systems including storage devices and hosts has also increased. Accordingly, there are continuing needs for storage devices to operate at higher speeds.

### SUMMARY

The inventive concept provides a data transmission method between storage devices providing an improved speed over peer-to-peer (P2P) connections via a peripheral component interconnect-express (PCIe), as well as a related storage device and a storage system.

In one aspect, the inventive concept provides a data retrieving method performed by a first storage device. The method includes; receiving a data request from a first host connected to the first storage device, providing data stored in a first data cache to the first host in response to the data request, requesting data transmission to a second storage device connected to the first storage device via a peripheral component interconnect-express (PCIe) connection in response to the data request, storing data transmitted from the second storage device in a second data cache, providing the data stored in the second data cache to the first host, and updating a cache replacement scheme for the data stored in the second data cache.

In another aspect, the inventive concept provides a first storage device connected to a first host, wherein the first storage system includes; a first memory region including memory cells, a first data cache configured to store read data retrieved from the first memory region in response to an input/output (I/O) request received from the first host, a second data cache configured to store data received from a second storage device including a second memory region and connected to the first storage device via a peripheral component interconnect-express (PCIe) connection in response to the I/O request received from the first host, and a cache replacement manager configured to perform a cache replacement scheme for the data stored in the second data cache, wherein data stored in at least one of the first data cache or the second data cache is transmitted to the first host.

In another aspect, the inventive concept provides a storage system including; a first host connected to a first storage device via a first channel; and a second host connected to a second storage device via a second channel, wherein the first storage device and second storage device are connected via a peripheral component interconnect-express (PCIe) connection, and the first storage device is configured to receive data from the second storage device in response to an input/output (I/O) request from the first host, store the received data in a data cache with corresponding cache replacement information, and transmit the data stored in the data cache to the first host.

In another aspect, the inventive concept provides a method of operating a storage system including a first host connected to a first storage device, and a second host connected to a second storage device, wherein the first storage device and second storage device are connected via a peripheral component interconnect-express (PCIe) connection. The method including; receiving in the first storage device a logical address provided by the first host, referencing a first mapping table of the first storage device to determine whether or not data identified by the logical address exists in a first memory region of the first storage device, upon determining that the data identified by the logical address does not exist in the first memory region, referencing a second mapping table of the first storage device to determine whether the data identified by the logical address exists in a second memory region of the second storage device, upon determining that the data identified by the logical address does exist in the second memory region, retrieving the data from the second storage unit via the PCIe connection and storing the data together with corresponding cache replacement information in the first storage device, and transmitting the data from the first storage device to the first host.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a storage system according to embodiments of the inventive concept;

FIG. 2 is a block diagram illustrating a storage device according to embodiments of the inventive concept;

FIG. 3 is a diagram for explaining operations of storage devices according to embodiments of the inventive concept;

FIG. 4 is a flowchart summarizing a method of operating the storage system of FIG. 1;

FIG. 5 is a diagram for explaining a method of operating a storage device according to embodiments of the inventive concept;

FIGS. 6A, 6B and 6C are respective graphs illustrating performance of a storage system according to an operation of a storage device according to embodiments of the inventive concept;

FIG. 7 is a block diagram illustrating a server system to which a storage device is applicable according to embodiments of the inventive concept; and

FIG. 8 is a block diagram illustrating a storage cluster to which a storage device is applicable according to embodiments of the inventive concept

### DETAILED DESCRIPTION

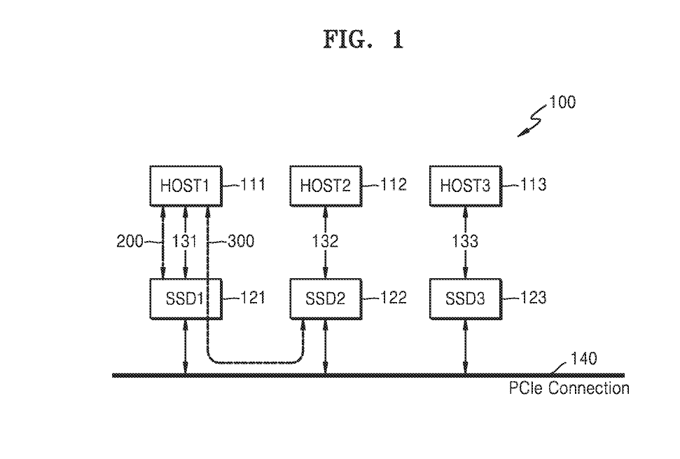

FIG. 1 is a block diagram illustrating a storage system 100 according to embodiments of the inventive concept.

Referring to the illustrated embodiment of FIG. 1, the storage system 100 includes a first host (HOST1) 111, a second host (HOST2) 112 and a third host (HOST3) 113, respectively connected to a first storage device 121, a second storage device 122, and a third storage device 123 via a first channel 131, a second channel 132, and a third channel 133.

The first storage device, second storage device and third storage device 121, 122 and 123 are connected to a PCIe connection 140.

The channels 131, 132 and 133 may be variously implemented as wired (e.g., cable connected) and/or wireless (e.g., network connected) links. For example, channels 131, 132 and 133 may networks of the generally understood by those skilled in the art. In this regard, channels 131, 132 and 133 may be fully or partially implemented using one or more wireless links (e.g., private or public links). Depending on the nature of such wireless links the channels 131, 132 and 133 may use global network(s), such as the Internet and the World Wide Web, a wide area network (WAN), and/or a local area network (LAN).

Each of the hosts 111, 112 and 113 may be an arbitrary computing system including, for example, one or more of a personal computer (PC), a server computer, a workstation, a laptop, a mobile phone, a smart phone, a personal digital assistant (PDA), a portable multimedia player (PMP), a digital camera, a digital television, a set-top box, a music player, a portable game console, and a navigation system.

The hosts 111, 112 and 113 may issue various input/output (I/O) request(s) respectively directed to the storage devices 121, 122 and 123. Hence, data access (e.g., reading, writing (or programming) and/or erasing) by the hosts 111, 112 and 113 to corresponding storage devices 121,122 and 123 is essentially exclusive. For example, an I/O request from the first host 111 may be issued to only the first storage device 121 via the first channel 131. The other storage devices 122 and 123 may not issues an I/O requested directed to the first storage device 121. Likewise, the I/O requests from the second and third hosts 112 and 113 may be respectively issued to the corresponding second and third storage devices 122 and 123 via the second and third channels 132 and 133. Hereinafter, for brevity of description, an I/O request issued from the first host 111 to the first storage device 121 will be assumed to be a “data request” recognizing that analogous I/O requests may be made from any host connection in the storage system 100.

In the illustrated embodiments of FIG. 1, the storage devices 121, 122 and 123 may include non-volatile memory-express (NVMe) solid state drives (SSDs), and/or peripheral component interconnect-express (PCIe) SSDs. The NVMe may be a scalable host controller interface designed to process the data processing requirements of enterprises, data centers, and/or client systems that use the SSDs. The NVMe may be used as an SSD device interface to provide a storage entity interface to the host.

The PCIe connection 140 includes a PCIe. And as will be understood by those skilled in the art, the PCIE is a high-speed serial computer expansion bus standard designed to replace at least one of the peripheral component interconnect (PCI) standard, the peripheral component interconnect-extended (PCI-X) standard, and the accelerated graphics port (AGP) bus standard. PCIe is based on a peer-to-peer (P2P) protocol and provides a higher maximum system bus throughput, a reduced I/O pin count, a smaller physical footprint, better performance-scaling for bus devices, and a more robust error detection and reporting mechanism. Within the system architecture suggested by FIG. 1, the NVMe will be in a position to define optimized register interfaces, command sets, and feature sets for PCIe SSDs, and to standardize the PCIe SSD interfaces by using functionality of the PCIe SSDs. Hence, storage devices 121, 122 and 123 may respectively be regarded as the PCIe SSDs having the NVMe interface for purposes of the present description.

The storage devices 121, 122 and 123 may be interconnected via PCIe connection 140 using plugging. That is, the PCIe connection 140 may include a bi-directional concurrent transmission serial message exchange link. A packet-based communication protocol in accordance with a PCIe interface specification may be implemented by the PCIe connection 140. For example, the PCIe connection 140 may optimize link parameters such as lane(s), link speed(s), and/or maximum payload size(s) between designated endpoints.

As further illustrated in FIG. 1, a first I/O path 200 may be established between the first host 111 and the first storage device 121, and a second I/O path 300 may be established between the first host 111 and the second storage device 122 via the first storage device 121. Expressions of the first and second I/O paths 200 and 300 in the illustrated embodiment of FIG. 1 are selected only to better describe certain technical aspects of the inventive concept. Many different I/O paths may be defined or established among hosts and/or storage devices in the storage system 100.

The first I/O path 200 provides information transmission between the first host 111 and the first storage device 121. Such “information transmission” (or “transmitting information”) may include one or more I/O request(s) issued by the first host 111 to the first storage device 121, a reply from the first storage device 121 in response to the I/O request, as well as a data transmission from the first storage device 121 in response to the I/O request. Here, the I/O request may include one or more addresses (e.g., logical addresses) identifying data that is the subject of I/O request. Hence, information transmission may occur in a direction from the first host 111 to the first storage device 121 via the first I/O path 200, and/or in a direction from the first storage device 121 to the first host 111.

Thus, the first I/O path 200 may be understood as operating in a first environment defined by the first storage device 121 receiving I/O request(s) from the first host 111 and responding to (or resolving) the received I/O request(s). Alternately, the first storage device 121 may be placed in a second environment in which the first storage device 121 is not capable of resolving I/O request(s) received from the first host 111. However, in this second operative environment, the first storage device 121 may provide caching solutions that enable flushing cached data to the second and third storage devices 122 and 123.

For example, in a data retrieval operation (e.g., a read operation) executed in response to a corresponding I/O request received from the first host 111, it may be determined that corresponding data (i.e., data identified by an address provided with the I/O request) is stored in (or “exists” in) the second storage device 122. In this case, the first storage device 121 may establish the second I/O path 300 shown in FIG. 1 connecting the first storage device 121 with the second storage device 122 via the PCIe connection 140. Once established the second I/O path 300 may transmit information between the first host 111, via the first channel 131, the first storage device 121, and the PCIe connection 140 to the second storage device 122.

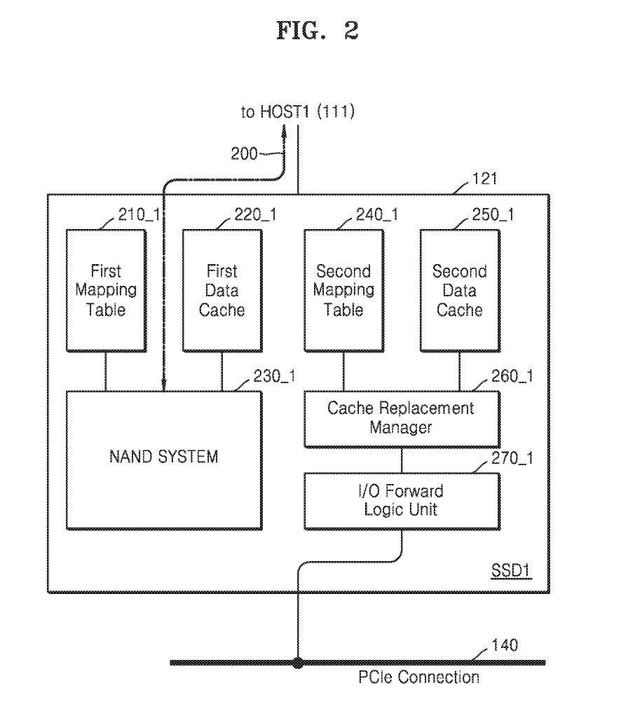

FIG. 2 is a block diagram further illustrating in one example the first storage device 121 of FIG. 1 according to embodiments of the inventive concept.

Referring to FIGS. 1 and 2, the first storage device 121 comprises a first mapping table 210_1, a first data cache 220_1, a negative-and (NAND) system 230_1, a second mapping table 240_1, a second data cache 250_1, a cache replacement manager 260_1, and an I/O forward logic unit 270_1. In addition, the first storage device 121 may further include a network interface controller supporting a network interface card, a network adapter, and/or a remote direct memory access (RDMA).

A competent RDMA protocol may be used to define RDMA messages (e.g., send, write, read messages, or the like) for data transmission. The first storage device 121 may perform certain management operation(s), such as allocating and/or de-allocating resources of the first storage device 121. The first storage device 121 may also “post” a work request (WR). For example, one management operation performed by the first storage device 121 may include allocating and de-allocating a queue pair (QP), allocating and de-allocating a completion queue (CQ), and/or allocating and de-allocating a memory.

The first storage device 121 may allocate the QP to which the WRs are posted. The QP may include a pair of work queues (e.g., transmit/receive), and may also include a posting mechanism for each queue. The first storage device 121 may post WRs to the work queues used to execute the posted WRs, where each work queue may be a list of work queue elements (WQE). The WQE may have some control information describing a WR and may refer (or point) to buffers provided within the first storage device 121. Information retained by the WQE may be, for example, a WR type and a description of buffers used to transmit data, or location information for received data.

Types of the WR may be classified into a Send WR, which may be an RDMA Send, an RDMA Write, an RDMA Read, or the like, and a Receive WR which may be an RDMA Receive. The WQE may be described as/correspond to a single RDMA message. When posting the Send WR of the RDMA Write type, the first storage device 121 may build, in a send queue (SQ) by using a RDMA Write message, the WQE describing buffers (or the first data cache 210_1), in which data needs to be obtained and transceived to and from the NAND system 230_1. As another example, when posting the Receive WR, the first storage device 121 may add the WQE to a receive queue (RQ) having a buffer (or the second data cache 250-1) to be used for arranging a payload of the received send message.

The first storage device 121 may be notified by a doorbell ring operation whenever the WQE is added to the SQ or the RQ. Here, the door ringing operation may be an operation that writes into a memory space of the first storage device 121 and is detected and decoded by hardware of the first storage device 121. Thus, the doorbell ringing operation may notify the first storage device 121 that new work exists that needs to be resolved in relation to certain SQ/RQ.

The first mapping table 210_1 may receive a logical address provided with the I/O request for a data transmission received from the first host 111. The first mapping table 210_1 may convert the received logical address to a corresponding physical address that identifies a physical location of memory cells to be accessed in the NAND system 230_1 associated with the first mapping table 210_1. Thus, the first mapping table 210_1 may store mapping information between logical address(es) received the first host 111 and corresponding physical address(es) of the NAND system 230_1. The logical address may be converted into the physical address by referring to the mapping information of the first mapping table 210_1, and the converted physical address may be provided to the NAND system 230_1. The NAND system 230_1 may then access the memory cells identified by the physical address(es).

The first data cache 220_1 may be used to read data from the memory cells of the NAND system 230_1 corresponding to the physical address and store the resulting read data. The read data stored in the first data cache 220_1 may be transmitted to the first host 111 via the first channel 131. Alternatively, the first data cache 220-1 may store write data to be written to memory cells identified by the physical address(es) of the NAND system 230_1. Accordingly, the first data cache 220-1 may function as a data buffer dedicated to the first storage device 121.

The NAND system 230_1, as a memory region of the first storage device 121, may include a flash storage array including NAND flash memory cells. Illustratively, the NAND system 230_1 may be implemented as an NVMe-over fabrics (NVMe-oF) extended to a fabric capable of communicating in a massively parallel manner.

The NAND system 230_1 may store in the first data cache 220_1 the read data retrieved from the memory cells corresponding to the converted physical address(es). Alternatively, the NAND system 230_1 may write (or program) write data stored in the first data cache 220_1 to the memory cells identified by the converted physical address(es).

The first I/O path 200 shown in FIG. 1 may include (or enable access to) the first mapping table 210_1, the NAND system 230_1, as well as a path bridged to or correlated with the first data cache 220_1. The first I/O path 200 may thus satisfy requests and responses between the first host 111 and the first storage device 121.

It is possible, however, that an I/O request issued from the first host 111 and received by the first storage device 121 may not be resolvable by the first storage device 121. For example, a logical address received by the first storage device 121 as part of an I/O request from first host 111 may identify (or be correlated with) a physical address associated with the second and/or third storage devices 122 and 123. In such a case, the first storage device 121 may execute a caching solution that enables cached data to be flushed to the second and/or third storage devices 122 and 123. In this regard, the first storage device 121 may use the second mapping table 240_1, the second data cache 250_1, the cache replacement manager 260-1, and the I/O forward logic 270-1 to provide improved data availability, performance capability, and ready scalability.

The second mapping table 240_1 may be used to convert the logical address addressing the second and third storage devices 122 and 123 into a corresponding physical address identifying the physical location of memory cells to be accessed in the NAND system in the second and/or third storage devices 122 and 123. Thus, the second mapping table 240_1 may be used to store mapping information between the logical address from the first host 111 and the physical address of the NAND system in the corresponding second and/or third storage devices 122 and 123.

The logical address from the first host 111 may be converted to the physical address of the NAND system in the second and/or third storage devices 122 and 123 by referring to the mapping information of the second mapping table 240_1, and the converted physical address may be provided to the I/O forward logic unit 270_1. The I/O forward logic unit 270_1 may be connected to the second and/or third storage devices 122 and 123 corresponding to the logical address from the first host 111 via the PCIe connection 140.

The second data cache 250_1 may store data read from the corresponding second and/or third storage devices 122 and 123 according to the access of the second and third storage devices 122 and 123 in response to the logical address from the first host 111. According to certain embodiments of the inventive concept, the second data cache 250_1 may store data to be written to the second and/or third storage devices 122 and 123 corresponding to the logical address from the first host 111.

In this regard, the second data cache 2501 may be understood as performing a preload operation for data directed to the second and/or third storage devices 122 and 123 based on an I/O request originating from the first host 111, or as performing a read operation for data retrieved from the second and/or third storage devices 122 and 123 to be processed by the first host 111. Accordingly, the second data cache 250_1 may function as a cache including high-speed buffer memories or multiple cache lines that store data received from the second and third storage devices 122 and 123.

The cache replacement manager 260_1 may be used to determine which data among data stored in the second data cache 250_1 is to be replaced. Replacement of data may be performed in cache lines units, or in block units, for example.

It is important that the first host 111 reduces access time of the second data cache 250_1 as much as possible. And the cache replacement manager 260_1 may use a cache replacement scheme to increase access success rate associated with use of the second data cache 250_1. Thus, the cache replacement scheme may include a least recently used (LRU) method, a least frequently used (LFU) method, a random method, a first in first out (FIFO) method, or the like.

The LRU method may replace (or expire) an LRU cache line or block. For example, each time the second data cache 250-1 is accessed, an LRU bit for a valid cache line may be renewed. The LRU bit denoting the recently accessed sequence may be used as information to notify the LRU block (or an oldest block) when the cache line replacement occurs. The LFU method may replace a least used block after having been stored in the second data cache 250_1. The random method may select and replace any block of the second data cache 250_1. The FIFO method may replace the oldest block stored in the second data cache 250_1.

The second data cache 250_1 may store data received from the second and/or third storage devices 122 and 123 along with cache replacement information. The cache replacement information may be information indicating data replacement implemented by any one of the LRU method, LFU method, random method, and FIFO method.

The I/O forward logic unit 270_1 may be used to determine a connection between the first storage device 121 and the second and third storage devices 122 and 123 in which data to be populated in the cache lines of the second data cache 250_1 is known to exist. For example, when it is determined that the logical address from the first host 111 accesses the second storage device 122 according to the second mapping table 240_1, the I/O forward logic portion 270_1 may provide connectivity for the second storage device 122 via the PCIe connection 140 so as to populate the second data cache 250_1 with the data of the second storage device 122.

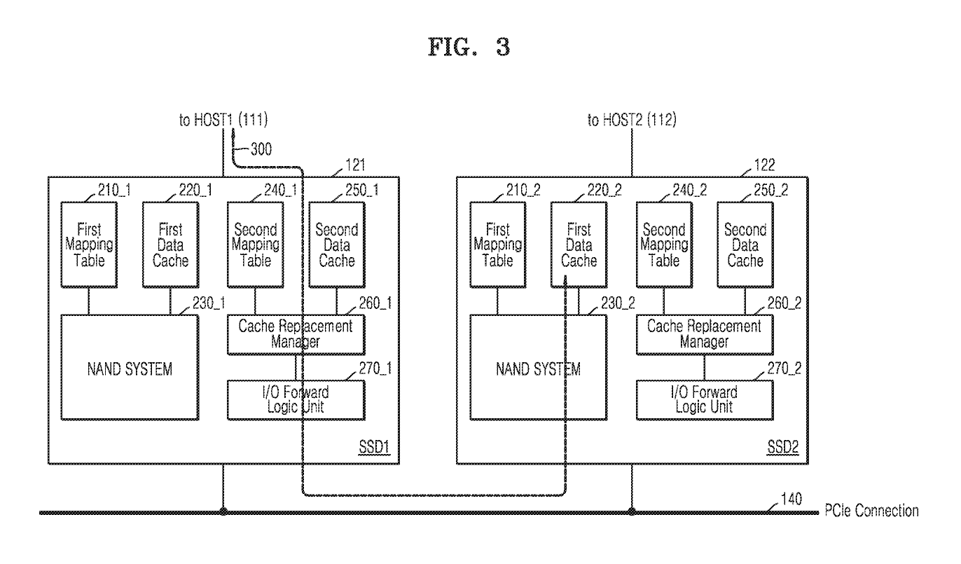

The second I/O path 300 shown in FIG. 1 may include the second mapping table 240_1, the second data cache 250_1, the cache replacement manager 260_1, and a portion or the entirety of a path bridged to or correlated with the I/O forward logic unit 270_1. One example of the establishment and use of the second I/O path 300 will be described in some additional detail with reference to FIG. 3.

FIG. 3 is a diagram further illustrating the establishment of the second I/O path 300 between the first and second storage devices 121 and 122 according to embodiments of the inventive concept.

Referring to FIG. 3, the first storage device 121 may include, as described with reference to FIG. 2, the first mapping table 210_1, the first data cache 220_1, the NAND system 230_1, the second mapping table 240_1, the second data cache 250_1, the cache replacement manager 260_1, and the I/O forward logic unit 270_1. The second storage device 122 may also include, similar to the first storage device 121, the first mapping table 210_2, the first data cache 220_2, the NAND system 230_2, the second mapping table 240_2, the second data cache 250_2, the cache replacement manager 260_2, and the I/O forward logic unit 270_2. Although the first storage device 121 and the second storage device 122 are described as being of the same type in the embodiment, the first storage device 121 and the second storage device 122 may be of different types in other embodiments.

The first storage device 121 may receive the logical address provided with the I/O request related to the data transmission received from the first host 111, and may determine, by referring to the second mapping table 240_1, whether the logical address from the first host 111 addresses the second storage device 122. The first storage device 121 may use the mapping information of the second mapping table (240_1 in FIG. 3) to determine whether the logical address provided with the I/O request corresponds to the physical address of the NAND system 230_2 of the second storage device 122.

The first storage device 121 may determine, by using the cache replacement manager 260_1, whether caching from the second storage device 122 to the second data cache 250_1 is needed. When the first storage device 121 determines it is necessary to cache the data of the second storage device 122 according to the I/O request from the first host 111 to the second data cache 250_1, the first storage device 121 may request the second storage device 122 to send the data. At this time, the first storage device 121 may be connected to the second storage device 122 via the PCIe connection 140 by using the I/O forward logic unit 270_1.

The second storage device 122 may, in response to the data request from the first storage device 121, convert the logical address from the first host 111 to the physical address by referring to the mapping information of the second mapping table 240_1 of the first storage device 121, and access the NAND system 230_2 corresponding to the converted physical address. The second storage device 122 may read data from the memory cells of the NAND system 230_2 corresponding to the converted physical address, and write the read data to the second data cache 250_1 of the first storage device 121. According to certain embodiments of the inventive concept, the data read from the NAND system 230_2 of the second storage device 122 may be stored (or buffered) in the first data cache 220_2 of the second storage device 122.

The first storage device 121 may include the second mapping table 240_1, the cache replacement manager 260_1, the I/O forward logic unit 270_1, the PCIe connection 140, the NAND system 230_2 of the second storage device 122, and the second I/O path bridged to or correlated with the second data cache 250_1. The first storage device 121 may transmit the data of the second storage device 122 cached in the second data cache 250_1 to the first host 111 via the second I/O path 300.

The first storage device 121 may determine, by using the cache replacement manager 260_1, that the caching from the second storage device 122 to the second data cache 250_1 is not needed. The first storage device 121 may identify whether the data of the second storage device 122 according to the I/O request from the first host 111 is in a valid state in a cache line of the second data cache 250_1, that is, a “cache hit”. The first storage device 121 may transmit the data of the second data cache 250_1 (or the cache hit) to the first host 111 through a portion of the second I/O path 300.

In FIG. 3, the first storage device 121 may function as a cache storage device that provides the caching solutions capable of flushing cached data to the second storage device 122 for data retrieval. In addition, the second storage device 122 may function as a data storage device.

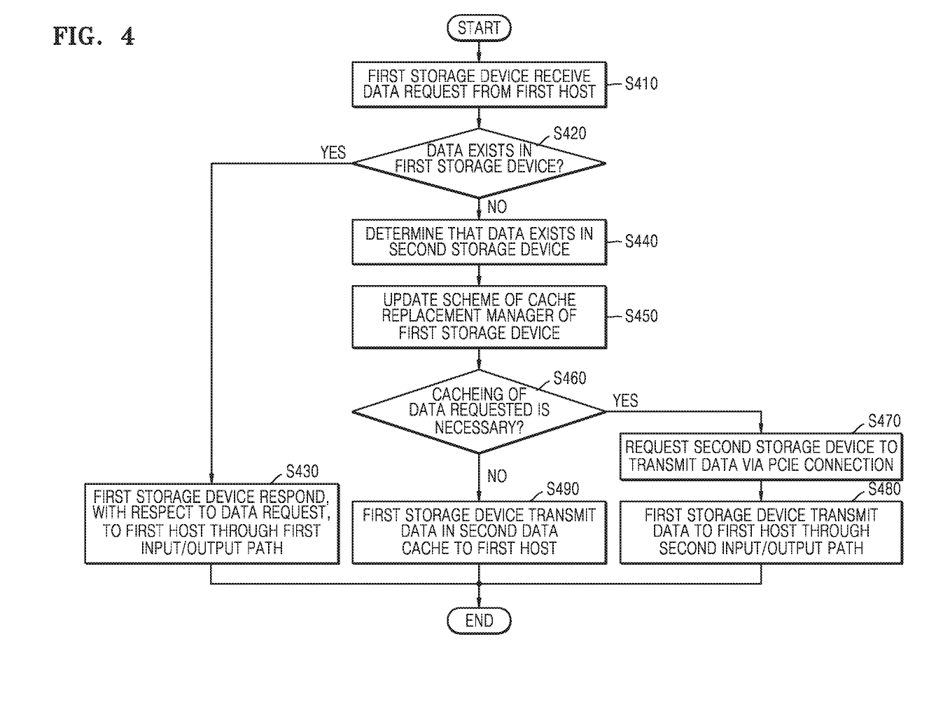

FIG. 4 is a flowchart summarizing in one embodiment a method of operating the storage system 100 of FIG. 1.

Referring to FIGS. 1, 2, 3 and 4, a method of retrieving data via the first storage device 121 in the storage system 100 by the first host 111 may include receiving, by the first storage device 121, an I/O request (hereafter, a “data request”) from the first host 111 (S410). A data request from the first host 111 may be issued for storage and retrieval services. The first storage device 121 may respond to the first host 111 to execute the received data request.

The first storage device 121 may then determine whether there is data corresponding to the received data request (S420). The first storage device 121 may use the mapping information of the first mapping table (210_1 in FIG. 2) to determine whether the logical address provided with the data request corresponds to the physical address of the NAND system (230_1 in FIG. 2) of the first storage device 121. When the logical address from the first host 111 corresponds to the physical address of the NAND system (230_1 in FIG. 2) of the first storage device 121, the first storage device 121 may determine that there exists data corresponding to the received data request. When it is determined that there exists data in the first storage device 121, the operation may proceed to step S430.

The first storage device 121 may convert the logical address into a physical address by referring to the mapping information of the first mapping table 210_1, read data from the memory cells of the NAND system 230_1 corresponding to the converted physical address, and store the read data in the first data cache (220_1 in FIG. 2) (S430). The first storage device 121 may respond, with respect to the data request, to the first host 111 through the first mapping table 210_1, the NAND system 230_1, and the first I/O path (200 in FIG. 2) bridged to or correlated with the first data cache 220_1.

When it is determined as a result of step S420 that there exists no data in the first storage device 121, the operation may proceed to step S440. The first storage device 121 may determine whether the logical address provided with the data request corresponds to the physical address of the NAND system (230_2 in FIG. 3) of the second storage device 122, by using the second mapping table (240_1 in FIG. 3) (S440). When the logical address from the first host 111 corresponds to the physical address of the NAND system (230_2 in FIG. 2) of the second storage device 122, the first storage device 121 may determine that there exists data corresponding to the received data request in the second storage device 122.

The first storage device 121 may update the cache replacement scheme of the cache replacement manager (260_1 in FIG. 3) for the flushing to the second storage device 122 (S450). The first storage device 121 may determine which data among data stored in the second data cache (250_1 in FIG. 3) is to be replaced.

Illustratively, when the cache replacement scheme is implemented by the LRU method, the first storage device 121 may renew the LRU bit for the valid cache line each time the second data cache (250_1 in FIG. 3) is accessed. The LRU bit may indicate the recently accessed sequence when the cache line replacement of the second data cache 250_1 occurs. According to an embodiment, the cache replacement scheme may use the LFU scheme, the random scheme, the FIFO scheme, or the like.

The first storage device 121 may determine whether the data of the second storage device 122 according to the data request from the first host 111 needs to be cached to the second data cache 250_1 (S460). When caching to the second data cache 250_1 is determined necessary, the operation may proceed to step S470.

The first storage device 121 may be connected to the second storage device 122 via the PCIe connection 140 by using the I/O forward logic unit 270_1, and request the second storage device 122 to transmit data (S470).

The first storage device 121 may convert the logical address into the physical address by referring to the mapping information of the second mapping table 240_1, read data from the memory cells of the NAND system 230_2 of the second storage device 122 corresponding to the converted physical address, and store the read data in the second data cache 250_1 (S480). The first storage device 121 may respond with respect to the data request to the first host 111 through the second mapping table 240_1, the cache replacement manager 260_1, the IO forward logic unit 270_1, the PCIe connection 140, the NAND system 230_2 and the first data cache 220_2 of the second storage device 122, and the second IO path 300 bridged to or correlated with the first host 111.

When the caching to the second data cache 250_1 is not needed in step S460, the operation may proceed to step S490. The first storage device 121 may identify that the data of the second storage device 122 according to the data request from the first host 111 is in a valid state in the cache line of the second data cache 250_1, that is, the cache hit, and may respond, with the data of the second data cache 250_1 having the cache hit, to the first host 111 in connection with the data request via the channel 131 (S490).

The method of operation in which the first storage device 121 functions as the cache storage device as described in FIG. 4 may be realized in a form of: program codes permanently stored on non-writable storage media such as ROM devices; changeable program codes stored on non-volatile recordable storage media such as floppy disks, magnetic tapes, compact discs (CDs), RAM devices and/or other magnetic and optical media; or program codes transmitted by a computer via communication media like electronic networks such as the Internet or telephone modem lines.

According to an embodiment, the method of operations in which the first storage device 121 functions as the cache storage device may be provided as a software executable medium or a computer program product implemented as a set of instructions encoded for execution by a processor in response to instructions.

According to an embodiment, the method of operations in which the first storage device 121 functions as the cache storage device may be partially or wholly implemented by using application specific integrated circuits (ASICs), field programmable gate arrays (FPGAs), state machines, controllers, or other hardware devices, or a combination of software, hardware, and firmware components.

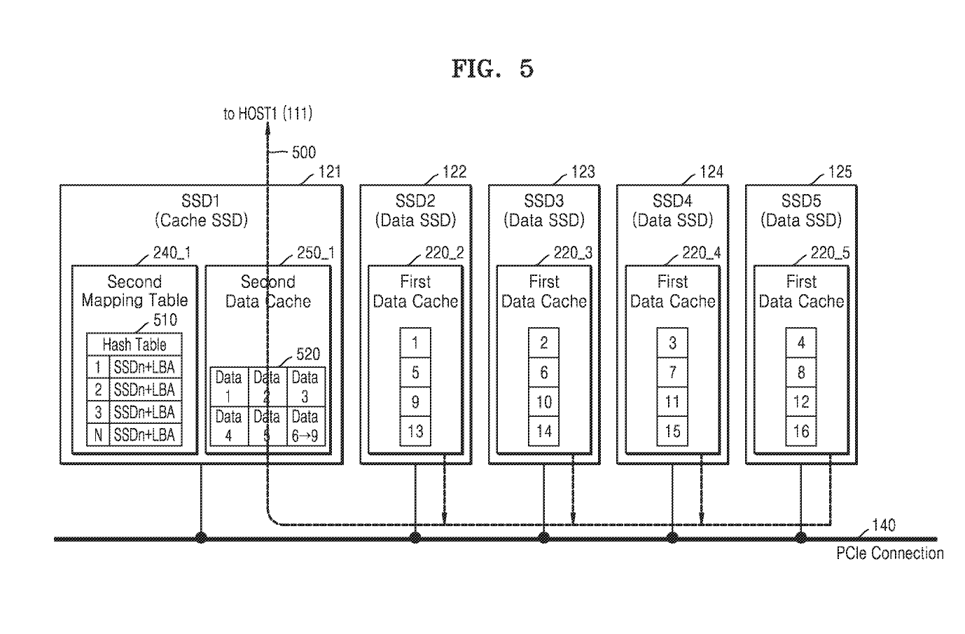

FIG. 5 is a diagram illustrating an arrangement and connection of first through fifth storage devices 121 through 125 according to embodiments of the inventive concept.

Referring to FIG. 5, the first storage device 121 may receive the logical address provided with the I/O request regarding the data transmission received from the first host 111. The first storage device 121 may refer to the second mapping table 240_1 to be implemented as a hash table 510 and convert the logical address from the first host 111 to the physical address of the second through fifth storage devices 122 through 125.

The hash table 510 may prepare an associative array such that the logical address from the first host 111 are mapped to the physical address of the NAND systems in the second through fifth storage devices 122 through 125. The hash table 510 may have a data structure of a directly accessible table-type in which indices are computed into an array of buckets or slots by using a hash function. The second mapping table 240-1 may hash the logical address from the first host 111 and may probe the address obtained from the hash function in the hash table 510.

When the logical address from the first host 111 is converted into the physical address by referring to the mapping information of the second mapping table 240_1, the first storage device 121 may request data transmission to the fifth storage devices 122 through 125 corresponding to the converted physical address.

The first storage device 121 may determine, by using the cache replacement manager 260_1, whether caching from the second through fifth storage devices 122 through 125 to the second data cache 250_1 is needed, and when it is determined that the caching is needed to the second data cache 250_1, the first storage device 121 may request data transmission to the second through fifth storage devices 122 through 125.

The second storage device 122 may, in response to the data request from the first storage device 121, refer to the mapping information of the second mapping table 240_1 of the first storage device 121 so as to access the NAND system (230_2 in FIG. 2) corresponding to the converted physical address. The second storage device 122 may read data from the memory cells of the NAND system 230_2 corresponding to the converted physical address, and write or buffer the read data to the first data cache 220_1 of the second storage device 122.

Each of the third through fifth storage devices 123 through 125 may, in response to the data request from the first storage device 121, refer to the mapping information of the second mapping table 240_1 of the first storage device 121 so as to access the NAND system corresponding to the converted physical address. Each of the third through fifth storage devices 123 through 125 may read data from the memory cells of the NAND system of the relevant storage device corresponding to the converted physical address, and may write the read data to the first data caches 220_3 through 220_5 of the corresponding storage device.

Illustratively, the first storage device 121 may refer to the second mapping table 240_1 to fill the cache line 520 of the second data cache 250_1 with data 1 stored in the first data cache 220_2 of the second storage device 122. The cache line 520 may be a replacement target cache line that is selected as in need of a cache replacement by the LRU method, the LFU method, the random method, or the FIFO method of the cache replacement manager (260_1 in FIG. 2).

The first storage device 121 may refer to the second mapping table 240_1 to fill the cache line 520, or a replacement target, of the second data cache 250_1 with data 2 stored in the first data cache 220_3 of the third storage device 123. The first storage device 121 may refer to the second mapping table 240_1 so as to fill the cache line 520, or a replacement target, of the second data cache 250_1 with data 3 and data 4, which are stored in the first data caches 220_4 and 220_5 of the fourth and fifth storage devices 124 and 125, respectively.

According to an embodiment, data that is filled in the cache line 520 via a connection path 500 between the first storage device 121 and the second through fifth storage devices 122 through 125 may be provided as a response to the I/O request from the first host 111. In addition, the data filled in the cache line 520 may be managed as an updated data by the cache policy manager 260_1.

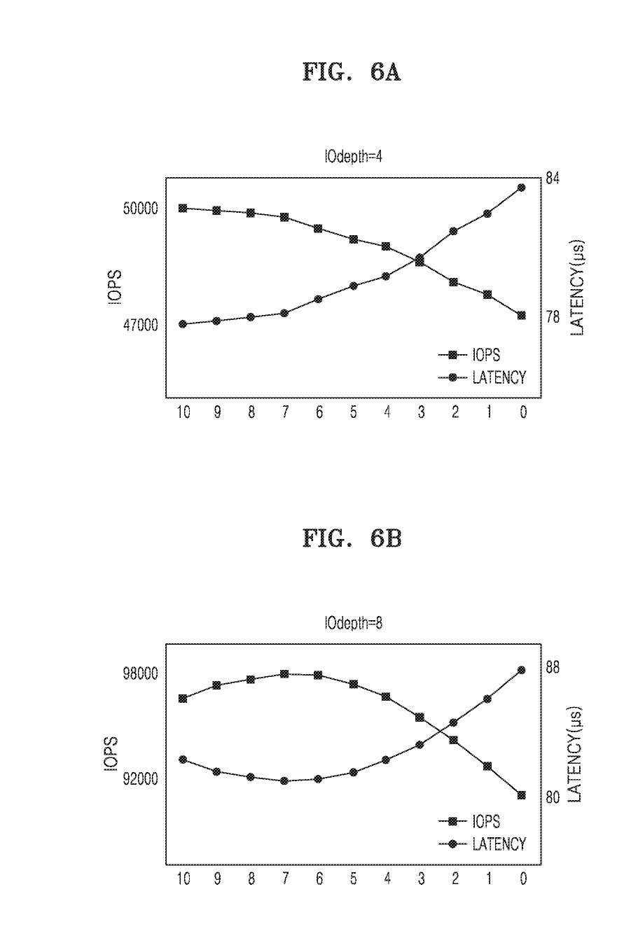

FIGS. 6A, 6B and 6C are respective graphs illustrating performance of the storage system 100 according to an operation of the first storage device 121 according to embodiments of the inventive concept. As FIGS. 6A, 6B and 6C illustrate, when the first storage device 121 functions as the cache storage device providing the caching solutions to flush the second and third storage devices 122 through 125 (with reference to FIG. 5), the performance of the first storage device 121 according to the number of work queues posted in the first storage device 121 or the I/O queue depth. The horizontal axis of FIGS. 6A, 6B and 6C indicate a rate at which the first storage device 121 processes the WRs from the first host 111. The left vertical axis of FIGS. 6A, 6B and 6C indicate the number of I/O operations processed per second (IOPS) in the first storage device 121, and the right vertical axis of FIGS. 6A, 6B and 6C indicate latency of I/O operations processed in the first storage device 121.

Referring to FIG. 6A, the number of I/O operations processed in the first storage device 121 (IOPS) and the latency are shown for the I/O depth of 4 posted in the first storage device 121. When the ratio of the WRs from the first host 111 processed by the first storage device 121 is high, or when a processing rate of the first storage device 121 is illustratively about 10, the number of I/O operations processed in the first storage device 121 (IOPS) may be relatively large, about 51000, and the latency may be relatively short, about 78 μs.

On the other hand, when the ratio of the WRs processed by the first host 111 is low, or when the processing rate of the first storage device 121 is illustratively about 1, the number of I/O operations processed in the first storage device 121 (IOPS) may be relatively small, about 47000, and the latency may be relatively long, about 78 μs.

As a result of such experiments, when the numbers of I/O operations (IOPS) in cases of large and small processing rates of the first storage device 121 with respect to I/O depth of 4 posted in the first storage device 121 are compared, it may be understood that there is a difference of about 10%.

Referring to FIG. 6A, the number of I/O operations processed in the first storage device 121 (IOPS) and the latency are shown for the I/O depth of 8 posted in the first storage device 121. When the ratio of the WRs from the first host 111 processed by the first storage device 121 is high, or when the processing rate of the first storage device 121 is illustratively about 10, the number of I/O operations processed in the first storage device 121 (IOPS) may be relatively large, about 98000, and the latency may be relatively short, about 80 μs.

On the other hand, when the ratio of the WRs processed by the first host 111 is low, or when the processing rate of the first storage device 121 is illustratively about 1, the number of I/O operations processed in the first storage device 121 (IOPS) may be relatively small, about 92000, and the latency may be relatively long, about 88 μs.

As a result of such experiments, when the numbers of I/O operations (IOPS) in cases of large and small processing rates of the first storage device 121 with respect to IO depth of 8 posted in the first storage device 121 are compared, it may be understood that there is a difference of about 10%.

Referring to FIG. 6C the number of I/O operations processed in the first storage device 121 (IOPS) and the latency are shown for the IO depth of 16 posted in the first storage device 121. When the ratio of the WRs from the first host 111 processed by the first storage device 121 is high, or when the processing rate of the first storage device 121 is illustratively about 10, the number of I/O operations processed in the first storage device 121 (IOPS) may be relatively large, about 180000, and the latency may be relatively short, about 90 μs.

On the other hand, when the ratio of the WRs processed by the first host 111 is low, or when the processing rate of the first storage device 121 is illustratively about 1, the number of I/O operations processed in the first storage device 121 (IOPS) may be relatively small, about 140000, and the latency may be relatively long, about 130 μs.

As a result of such experiments, when the numbers of IO operations (IOPS) in cases of large and small processing rates of the first storage device 121 with respect to IO depth of 16 posted in the first storage device 121 are compared, it may be understood that there is a difference of about 10%.

In the examples shown in FIGS. 6A, 6B and 6C, it may be understood that, with respect to the I/O depths of 4, 8, and 16 posted in the first storage device 121, the number of I/O operations (IOPS) when the processing rate of the first storage device 121 is small shows a difference of about 10% less than the number of IO operations (IOPS) when the processing rate of the first storage device 121 is large. This may indicate that performance of the storage system (100 of FIG. 1) is less affected even though the processing rate is reduced as the data of the other storage devices is cached via the PCIe connection 140. In addition, since utilization rate of the cached data is increased as the cache replacement scheme is updated with respect to the data cached in the first storage device 121, data transmission speed of the storage system 100 may be improved.

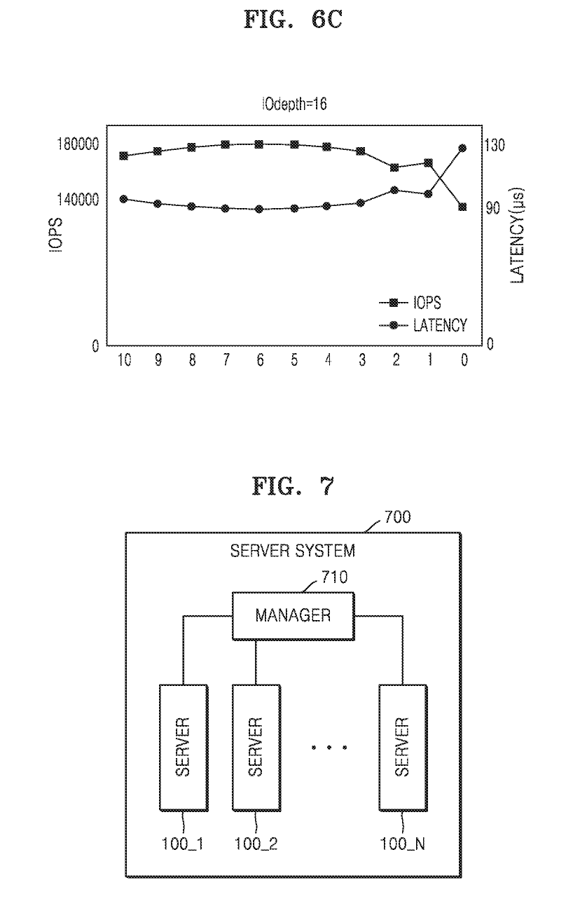

FIG. 7 is a block diagram illustrating a server system 700 to which a storage device according to embodiments of the inventive concept may be incorporated.

Referring to FIG. 7, the server system 700 may include a plurality of servers 110_1, 110_2, . . . , 110_N, where ‘N’ is an integer. The plurality of servers 110_1, 110_2, . . . , 110_N may be connected to a manager 710. The plurality of servers 110_1, 110_2, . . . , 110_N may be the same as or similar to the first storage device 121 described in FIGS. 1 through 5. Any one of the plurality of servers 110_1, 110_2, . . . , 110_N receiving a request of the manager 710 may cache data of the other server via the PCIe connection 140 in response to the request of the manager 710, transmit the cached data to the manager 710, and apply the cache replacement scheme for the cached data. The plurality of servers 110_1, 110_2, . . . , 110_N may communicate with each other by using the P2P protocol.

Each of the plurality of servers 110_1, 110_2, . . . , 110_N may include a memory region including a plurality of memory cells, a first data cache storing data read from the memory region in response to a request from the manager 710, a second data cache storing data to be transmitted from another server connected via the PCIe connection in response to the request to the manager 710, and a cache replacement manager performing a cache replacement scheme for data stored in the second data cache, wherein the data stored in the first data cache or the second data cache is transmitted to the manager 710. Each of the plurality of servers 110_1, 110_2, . . . , 110_N may further include a first mapping table converting the logical address received along with the request of the manager 710 to the physical address of the memory region of the corresponding server, and second mapping table converting the logical address to the physical address of the memory region of the other server.

The data stored in the second data cache may be updated or cache replaced depending on any one of the LRU method updating the LRU bit for a valid cache line each time the second data cache is accessed, the LFU method replacing the least recently used block after having been stored in the second data cache, the random method selecting and replacing an arbitrary block in the second data cache, and the FIFO method replacing the oldest block stored in the second data cache.

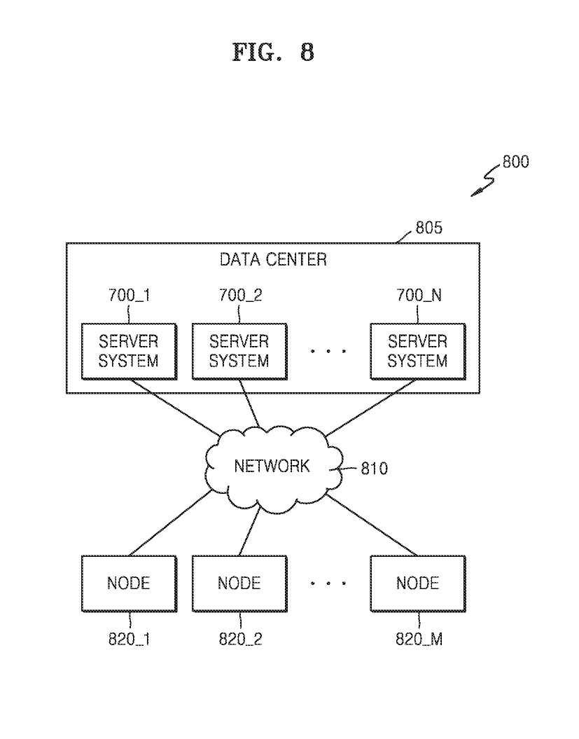

FIG. 8 is a block diagram illustrating a storage cluster 800 to which a storage device according to embodiments of the inventive concept may be incorporated.

Referring to FIG. 8, the storage cluster 800 may be regarded as a high-performance computing infrastructure capable of fast calculation of large amount of data in an age of big data and artificial intelligence (AI). The storage cluster 800 may increase computation performance by configuring a parallel computing environment through a large-scale clustering. The storage cluster 800 may provide a network-connected storage or a storage area network, depending on an amount of storage memory and flexible and reconfigurable arrangement of physical components.

The storage cluster 800 may include a data center 805 implemented by a plurality of server systems 700_1, 700_2, . . . , 700_N. Each of the plurality of server systems 700_1, 700_2, . . . , 700_N may be similar or identical to the server system 700 shown in FIG. 7.

The plurality of server systems 700_1, 700_2 . . . 700_N may communicate with various storage nodes 820_1, 820_2, . . . , 820_M, where ‘M’ is an integer, via a network 810 such as a computer network (e.g., LAN or WAN) or the Internet. The storage nodes 820_1, 820_2, . . . , 820_M may not need to be sequential or adjacent to each other according to some embodiments. For example, the storage nodes 820_1, 820_2, . . . , 820_M may be any one of client computers, other servers, remote data centers, and storage systems.

Each of the server systems that receive requests from the storage nodes 820_1, 820_2, . . . , 820_M among the plurality of server systems 700_1, 700_2, . . . , 700_N may cache data of other server system via the PCIe connection 140 in response to requests of storage nodes 820_1, 820_2, . . . , 820_M, transmit the cached data to the storage nodes 820_2, . . . , 820_M, and apply the cache replacement scheme to the cached data. The plurality of server systems 700_1, 700_2, . . . , 700_N may communicate with each other by using the P2P protocol.

Each of the plurality of server systems 700_1, 700_2, . . . , 700_N may include a plurality of servers. Each of the plurality of servers includes a memory area including a plurality of memory cells, a first mapping table converting the logical address received along with a request of the storage nodes 820_1, 820_2, . . . , 820_M to the physical address of the memory region of the corresponding server, a second mapping table converting the logical address to the physical address of the memory region of other server a logical address to a physical address of a memory area of another server, a first data cache storing data read from the memory region of the corresponding server in response to a request from the storage nodes 820_1, 820_2, . . . , 820_M, a second data cache storing data transmitted from other server connected via the PCIe connection 140 in response to the request from the storage nodes 820_1, 820_2, . . . , 820_M, and a cache replacement manager performing a cache replacement scheme for the data stored in the second data cache. Data stored in the first data cache or the second data cache may be transmitted to the storage nodes 820_1, 820_2, . . . , 820_M.

While the inventive concept has been particularly shown and described with reference to example embodiments thereof, it will be understood by one of ordinary skill in the art that various changes in form and details may be made therein without departing from the scope of the inventive concept as defined by the following claims.

1. A data retrieving method performed by a first storage device, the method comprising:
receiving a data request from a first host connected to the first storage device;
providing data stored in a first data cache to the first host in response to the data request;
requesting data transmission to a second storage device connected to the first storage device via a peripheral component interconnect-express (PCIe) connection in response to the data request;
storing data transmitted from the second storage device in a second data cache;
providing the data stored in the second data cache to the first host; and
updating a cache replacement scheme for the data stored in the second data cache.

2. The method of claim 1, wherein the providing of the data stored in the first data cache to the first host in response to the data request comprises:
converting a logical address received with the data request to a physical address of a memory region of the first storage device;
reading data from memory cells of the memory region identified by the physical address; and
storing the read data in the first data cache.

3. The method of claim 1, wherein the requesting of data transmission to the second storage device connected to the first storage device in response to the data request comprises:
converting a logical address received with the data request to a physical address of a memory region of the second storage device; and
connecting the first storage device and the second storage device via the PCIe connection.

4. The method of claim 3, wherein the storing of the data transmitted from the second storage device into the second data cache comprises:
reading data from memory cells of the memory region of the second storage device identified by the physical address; and
storing the read data in the second data cache of the first storage device via the PCIe connection.

5. The method of claim 3, wherein the storing of the data transmitted from the second storage device into the second data cache further comprises:
reading data from memory cells of the memory region of the second storage device identified by the physical address;
storing the read data in a first data cache of the second storage device; and
storing data of the first data cache of the second storage device in the second data cache of the first storage device via the PCIe connection.

6. The method of claim 1, wherein the updating of the cache replacement scheme for the data stored in the second data cache comprises performing a least recently used (LRU) method in which an LRU bit for a valid cache line is updated each time the second data cache is accessed.

7. The method of claim 1, wherein the updating of the cache replacement scheme for the data stored in the second data cache comprises performing a least frequently used (LFU) method in which an LFU block is replaced after having been stored in the second data cache.

8. The method of claim 1, wherein the updating of the cache replacement scheme for the data stored in the second data cache comprises performing a random method in which an arbitrary block of the second data cache is selected and replaced.

9. The method of claim 1, wherein the updating of the cache replacement scheme for the data stored in the second data cache comprises performing a first in first out (FIFO) method in which an oldest block after having been stored in the second data cache is replaced.

10. The method of claim 1, wherein communication between the first storage device and the second storage device via the PCIe connection is performed using a peer-to-peer (P2P) protocol.

11. A first storage device connected to a first host, the first storage system comprising:
a first memory region including memory cells;
a first data cache configured to store read data retrieved from the first memory region in response to an input/output (I/O) request received from the first host;
a second data cache configured to store data received from a second storage device including a second memory region and connected to the first storage device via a peripheral component interconnect-express (PCIe) connection in response to the I/O request received from the first host; and
a cache replacement manager configured to perform a cache replacement scheme for the data stored in the second data cache,
wherein data stored in at least one of the first data cache or the second data cache is transmitted to the first host.

12. The storage device of claim 11, further comprising:
a first mapping table configured to receive a logical address provided with the I/O request from the first host, and convert the logical address to a physical address of the first memory region; and
a second mapping table configured to convert the logical address to a physical address of the second memory region of the second storage device.

13. The storage device of claim 11, wherein the second mapping table is configured to hash the logical address, probe an address obtained from a hash function in a hash table, and convert the probed address into the physical address.

14. The storage device of claim 11, wherein the cache replacement manager is configured to replace data of the second data cache by using any one of a LRU method, a LFU method, a random method, and a FIFO method.

15-20. (canceled)

21. A method of operating a storage system including a first host connected to a first storage device, and a second host connected to a second storage device, wherein the first storage device and second storage device are connected via a peripheral component interconnect-express (PCIe) connection, the method comprising:
receiving in the first storage device a logical address provided by the first host;
referencing a first mapping table of the first storage device to determine whether or not data identified by the logical address exists in a first memory region of the first storage device;
upon determining that the data identified by the logical address does not exist in the first memory region, referencing a second mapping table of the first storage device to determine whether the data identified by the logical address exists in a second memory region of the second storage device;
upon determining that the data identified by the logical address does exist in the second memory region, retrieving the data from the second storage unit via the PCIe connection and storing the data together with corresponding cache replacement information in the first storage device; and
transmitting the data from the first storage device to the first host.

22. The method of claim 21, wherein the cache replacement information is implemented by any one of an LRU method, an LFU method, a random method, and a FIFO method, and denotes data replacement of the data cache.

23. The method of claim 21, wherein the first storage device and the second storage device communicate with each other via the PCIe connection using a P2P protocol.

24. The method of claim 21, wherein each one of the first storage device and second storage device comprises one of a PCIe solid state drive (SSD), a non-volatile memory-express (NVMe) SSD, and a flash-or-NAND-based media.

25. The method of claim 21, further comprising:
converting the logical address to a corresponding physical address for the second memory region using a hash table.

26. The method of claim 21, further comprising:
issuing an input/output (I/O) request including the logical address from the first host to the first storage device, wherein the referencing of the first mapping table of the first storage device to determine whether or not data identified by the logical address exists in a first memory region of the first storage device, the referencing of the second mapping table of the first storage device to determine whether the data identified by the logical address exists in a second memory region of the second storage device, the retrieving of the data from the second storage unit via the PCIe connection and the storing of the data together with corresponding cache replacement information in the first storage device, and the transmitting of data from the first storage device to the first host are performed in response to the I/O request.
